(19) United States
(12) Patent Application Publication
(10) Pub. No.: US 2004/0120516 A1
(43) Pub. Date: Jun. 24, 2004

(54) Modular reduction method which recognizes special conditions

(75) Inventors: Chin-Long Chen, Fishkill, NY (US); Tamas L. Visegrady, Poughkeepsie, NY (US)

Correspondence Address: Lawrence D. Cutter, Sr. Attorney, IBM Corporation, Intellectual Property Law Dept., 2455 South Rd., M/S P386, Poughkeepsie, NY, 12601, US

(73) Assignee: International Business Machines Corporation, Armonk, NY

(21) Appl. No.: 10/328,286

(22) Filed: Dec. 23, 2002

(51) Int. Cl. H04K 1/00

(52) U.S. Cl. 380/28

(57) ABSTRACT

Modular reduction and modular multiplication for large numbers are required operations in public key cryptography. Moreover, efficient execution of these two operations is important to achieve high performance levels in cryptographic engines and processes. The present invention uses multiplication and addition instead of using division and subtraction to perform modular arithmetic. The present invention also achieves some of its advantages through processing which begins with the high order bits coupled with judicious observations pertaining to circumstances under which carry output signals from addition operations are generated. These carry output signals are used to provide corrections which thus enable the use of the higher order bits and the efficiencies that such use engenders. Additionally, the method of the present invention recognizes special circumstances that are employed to speed up processing.

### BACKGROUND OF THE INVENTION

The present invention is generally directed to circuits and methods for use in public key cryptography. Accordingly, the present invention is directed to computations involving modular arithmetic, that is, arithmetic modulo an integer N where N is typically very large and where the result is the remainder after a conventional division by N. More particularly, the present invention is directed to circuits and methods for performing modular reductions, a form of division when, in A mod N, A has one more digit than N. Even more particularly the present invention represents an improvement upon application Ser. No. 10/263,032 filed on Oct. 2, 2002, the contents of which are also included herein. In particular, the present invention determines conditions which permit direct calculation of the A mod N result without incurring the time costs associated with additional iterations.

Modular reduction and modular multiplication are two elementary operations that are carried out in most public key cryptography systems. Several techniques are known for performing these operations. For example, to calculate the modular reduction of A modulo N, that is, to determine the remainder when A is divided by N, there are essentially two approaches: the conventional method and the Montgomery method. Both of these methods reduce the number of significant digits of A mod N in a sequential process. The conventional method reduces the number of significant bits in A mod N starting from the most significant digits by a process of division and subtraction. On the other hand, the Montgomery method reduces the number of significant digits using a process of multiplication followed by addition starting instead from the least significant digits. In the conventional method, the quotient of the most significant digits of A divided by N is obtained first. Then the product of the quotient and the modulus N is subtracted from A. The resultant number is the answer if it is less than the modulus. If the resultant number is not less than the modulus, then the division and subtraction process continues. In the Montgomery method, A is added to the product of N and a single digit calculated from the least significant digit of A. The least significant digit of the sum of this addition is zero. Thus, the sum is shifted one digit to the right to remove the least significant digit. In the Montgomery method, these steps are repeated m times, where m is the number of significant digits in N. At the end of the process, the resultant number is (A/R^{m}) mod N, where R is the value that a single digit can represent. The complex operation of division is not required in the Montgomery method. However, the Montgomery method produces a transformed result. Preprocessing and post processing are required in the Montgomery method to obtain the final result.

### SUMMARY OF THE INVENTION

In accordance with a preferred embodiment of the present invention there is provided a method for modular reduction. The method produces A mod N, where A is a binary number considered as having n blocks with k bits each and where N is a binary number considered as having m blocks of k bits each. The method comprises the steps of:

loading the value R_{N}=R^{m+1} mod N, where R=2^{k}, into a first register;

loading a second register for the variable Z with the high order m blocks for A; and

for values of i ranging from n−1 to m+1, replacing the value in said second register with the value Z−ZᵢRⁱ+ZᵢR_{N}R^{i-m-1}, but if the addition operation produces a carry out indication, replacing the value in said second register instead with the value Z−ZᵢRⁱ+ZᵢR_{N}R^{i-m-1}−Rⁱ+R_{N}R^{i-m-1}, where Z is the current value in said second register and Zᵢ is the high order k bits in said second register and shifting said second register left and shifting into, on the right thereof, the next k bit block of A and determining if the contents of said second register are less than 2 k bits and if so determining A mod N without further iteration from a subportion of said second register. The present invention is an improvement on the method described in the aforementioned related patent application in that the contents of the second register are tested to determine when this value is less than 2 k bits. In this situation the result, A mod N, is computed directly without the need for further iterations. This direct calculation is carried out via the expressions seen in equations 3 and 5 more particularly described below.

Accordingly, it is an object of the present invention to construct circuits for performing operations of modular reduction particularly where the numbers involved are large.

It is also an object of the present invention to provide methods for carrying out modular arithmetic operations which avoid the disadvantages which exist in currently available approaches to the problem.

It is a still further object of the present invention to advance the state of the art in public key cryptography.

It is yet another object of the present invention to produce circuits for public key cryptography which are less complicated and which can carry out modular reductions rapidly and efficiently.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a block diagram of a circuit in accordance with a prior invention for carrying out modular reduction operations;

FIG. 2 is a block diagram of a circuit in accordance with a first embodiment of the prior invention for carrying out modular multiplication;

FIG. 3 is a block diagram of a circuit in accordance with a second embodiment of the prior invention for carrying out modular multiplication;

FIG. 4 is a schematic block diagram illustrating the overall processing structure of the processing carried out in the prior application, as seen as a view “on the other side of the sliding window” that is provided when the process is viewed from the iterative view.

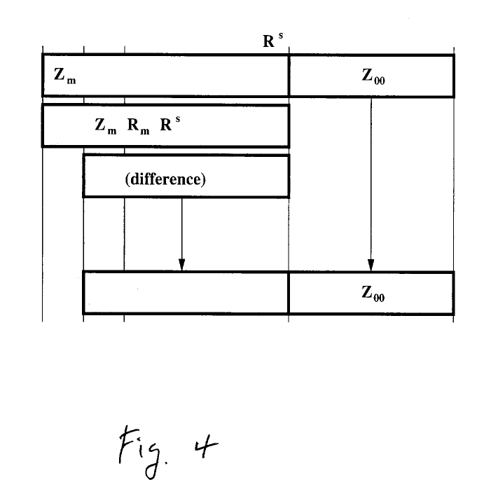

FIG. 5 is a schematic block diagram similar to FIG. 4 but more particularly illustrating the logical basis for understanding the present process improvement; and

FIG. 6 is a schematic block diagram similar to FIG. 4 but more particularly illustrating the possible existence of an extra bit in the improved process of the present invention.

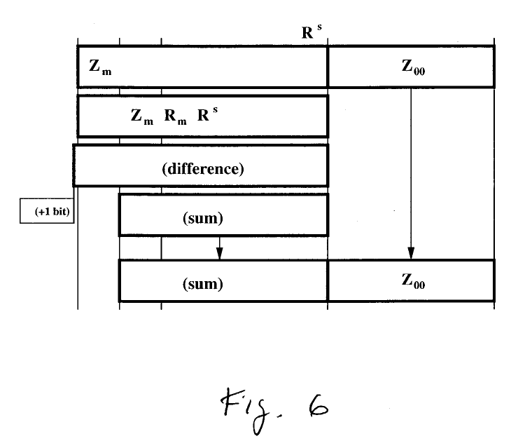

### DETAILED DESCRIPTION OF THE INVENTION

The present invention is particularly directed to a method of finding A mod N where A is has one more digit than N. Theoretically, if the quotient q=└A/N┘ is determined (where └x┘ represents the greatest integer less than x), then then A mod N=A−qN. In the present invention there is provided a quick and easy way to obtain an estimate q′ of the quotient q, then to calculate A−q′N, and then to make an adjustment if the estimate q′ is not exact.

Since the present invention is an improvement on prior submitted application Ser. No. 10/263,032, the contents of that application are discussed first.

### Prior Patent Application

In the prior application a new approach in the calculation of A mod N is provided. As in the conventional method, the prior invention produces A modulo N sequentially starting from the most significant digits. However, the prior invention employs multiplication and addition instead of division and subtraction. However, in contrast to the Montgomery method, there is no “baggage” involving preprocessing or involving post processing.

The modular reduction method of the prior invention is described first. Following that description, there is provided a description of how that method is applied to modular multiplication. Two schemas for modular multiplication are described.

### Modular Reduction

The numbers involved in cryptographic applications are usually very large. For example, values for the modulus N may be in the order of thousand bits. Accordingly, for purposes of both descriptional and operational efficiency, certain numbers herein are represented as polynomials in R, where R=2^{k}. In particular, we represent A as Aₙ₋₁Rⁿ⁻¹+ . . . +A₁R+A₀ and N as Nₘ₋₁R^{m-1}+ . . . +N₁R+N₀, where the values of the coefficients of the polynomials lie between 0 and 2^{k}−1, where Aₙ₋₁ and Nₘ₋₁ are not zero and where, in general, n is larger than m.

The following notation is also used in the prior description, which provides a view of both why and how the methods and circuits herein work to perform the desired functions. The remainder of A divided by N is referred to as Z, where Z=A mod N. The standard congruence relation A≡B mod N says that A and B have the same remainder when they are divided by N. One of the objectives herein is to obtain the value Z=A mod N, where Z is the remainder of A divided by N, as just specified. The prior approach is to efficiently obtain Z′ with m+1 digits such that the remainder of Z′ divided by N is equal to Z, that is, Z=Z′ mod N, and Z′≡A mod N. To obtain Z from Z′, one can use any variation of the conventional method. The preferred method herein precalculates and stores a constant value R_{N}=R^{m+1} mod N. Note that N is less than R^{m} and R_{N} is less than N. Thus, R_{N}<R^{m}−1.

Consider a polynomial C=Cₘ₊₁R^{m+1}CₘR^{m}+ . . . +C₁R+C₀ that represents an (m+2) digit number. A process for finding a polynomial that represents an (m+1) digit number and is congruent to C modulo N is demonstrated below.

Suppose that Let C′=CₘR^{m}+ . . . +C₁R+C₀, which is C with the most significant digit removed, that is, C=Cₘ₊₁R^{m+1}+C′. Since R_{N}=R^{m+1} mod N, we have C″=Cₘ₊₁R_{N}+C′≡C mod N. Furthermore, C′<R^{m+1}, Cₘ₊₁<R, and R_{N}<R^{m}−1, thus C″<2R^{m+1}. That is, the addition of two (m+1) digit numbers Cₘ₊₁R_{N} and C′ may have a carry of value no more than one.

If the carry is zero, C″ is an (m+1) digit number congruent to C modulo N. If the carry is one, then set C′″=(C″−R^{m+1})+R_{N}. Then C′″≡C mod N. It is now shown that C′″ is an (m+1) digit number. We note that:

C″=Cₘ₊₁R_{N}+C′≦(R−1)(R^{m}−2)+R^{m+1}−1, and

C′″=(C″−R^{m+1})+R_{N}≦(R−1)(R^{m}−2)+R^{m+1}−1−R^{m+1}+R^{m}−2.

Thus, C′″≦R^{m+1}−2R−1. Therefore, the addition of (C″−R^{m+1}) and R_{N} for C′″ produces no carry and C′″ has (m+1) digits, as stated above.

This process can be taken one step further: suppose that C=Cᵢ₊₁Rⁱ⁺¹+CᵢRⁱ+ . . . +C₁R+C₀ is an (i+2) digit number, C′=CᵢRⁱ+ . . . +C₁R+C₀, and C′=Cᵢ₊₁R_{N}R^{i-m}+C′. Then C′≡C mod N. In addition, C″ is less than 2Rⁱ⁺¹. If C″ is less than Rⁱ⁺¹, C″ is an (i+1) digit number. If C″ is greater than Rⁱ⁺¹−1, then C′″=C″−Rⁱ⁺¹+R_{N}R^{i-m}≡C mod N and C′″ is an (i+1) digit number. This modular digit reduction process is used repetitively to obtain a number of (m+1) digits congruent to C modulo N.

Accordingly, based on the process and the results indicated above, the following algorithm is thus seen to be employable to achieve modular reduction:

Modular Reduction Algorithm: Z=A mod N

Inputs to the process:

A=Aₙ₋₁Rⁿ⁻¹+ . . . +A₁R+A₀

N=Nₘ₋₁R^{m-1}+ . . . +N₁R+N₀

R=2^{k}; typically, n>m (if not the result is obtained trivially).

R_{N}=R^{m+1} mod N, R_{N}<N

1. Z=A

=Zₙ₋₁Rⁿ⁻¹+ . . . +Z₁R+Z₀

2. For i=n−1 to m+1, do

Z=Z−ZᵢRⁱ+ZᵢR_{N}R^{i-m-1}

If Zᵢ≠0, Z=Z−Rⁱ+R_{N}R^{i-m-1}

3. Repeat step 2 to obtain a sequential modular reduction on Z to a value such that Z<N.

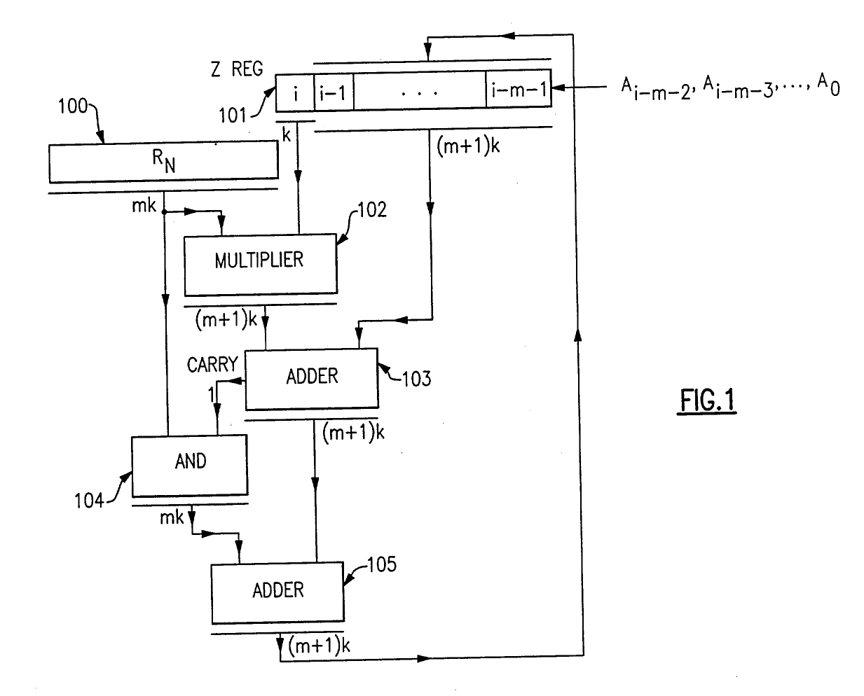

A block diagram is shown in FIG. 1 which provides a hardware implementation of steps 1 and 2 of the modular reduction algorithm described above. The value of R_{N} is stored in R_{N} register 100. Z register 101 is a shift register whose low order (m+1) digits holds the temporary result. The low order digit of Z register 101 is filled with the next high order digit of A as Z register is shifted to the left (high order positions) in one of the (n−m−1) iterations. Multiplier 102 multiplies R_{N} by the single digit number Zᵢ from the leftmost k bits of Z register 101 to produce an (m+1) digit output. Adder 103 is then used to produce the sum of the output of multiplier 102 and the low order (m+1) digits of Z register 101. R_{N} is added, by means of adder 105, to the output of adder 103 only if the carry output signal from adder 103 is “1” (that is, if and only if a carry occurs). Accordingly, the output from R_{N} register 100 is supplied to AND gate 104 whose other input is the aforementioned carry signal from adder 103. The result from adder 105 is then put back into Z register 101 to end one iteration. The process is repeated until the contents of Z register 101 are less than or equal to N.

### Modular Multiplication

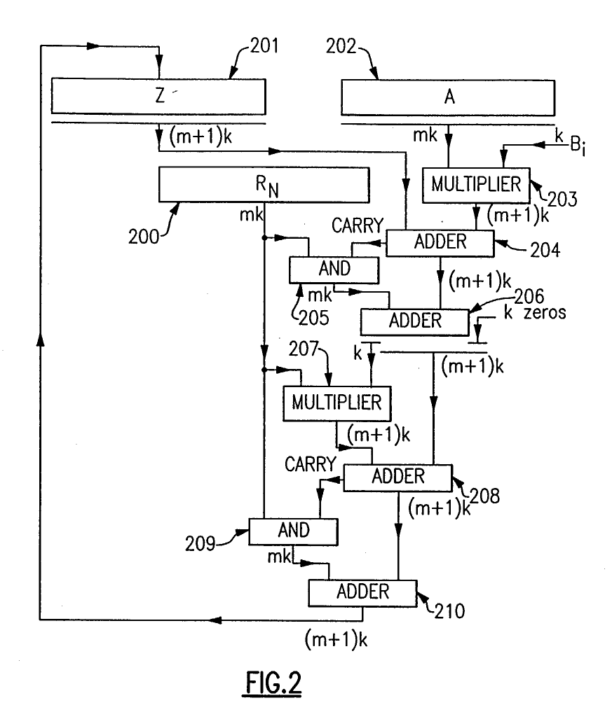

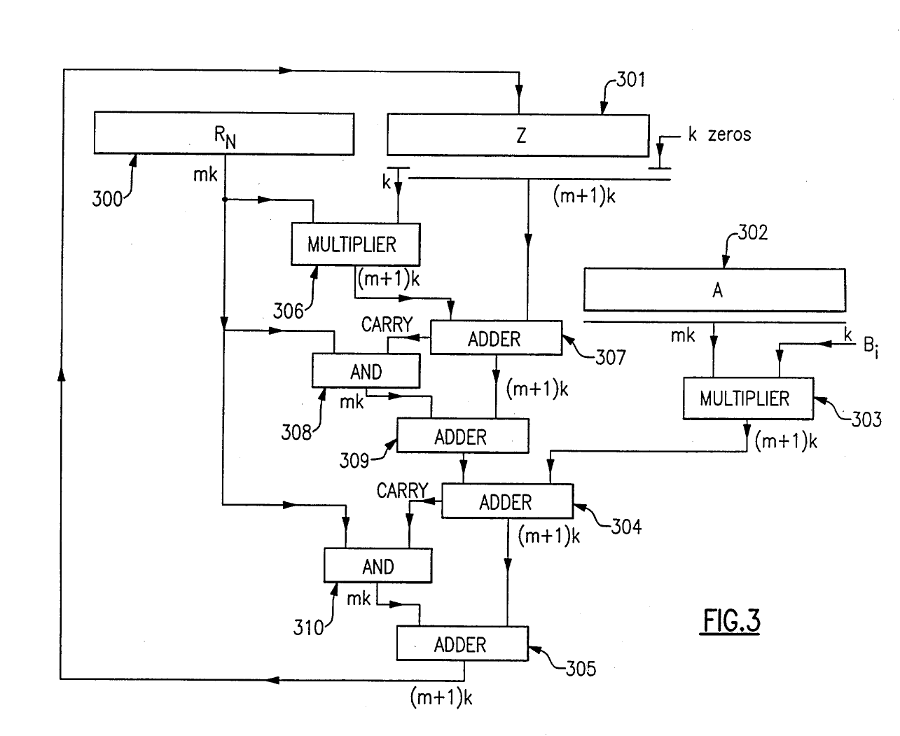

The prior invention provides two methods and two circuits for calculating A×B modulo N. The process and method described and illustrated in FIG. 2 is referred to herein as Algorithm I. The process and method described and illustrated in FIG. 3 is referred to herein as Algorithm II. Both of these are now described in detail, beginning with Algorithm I.

The calculation of A×B modulo N can be carried out by first obtaining the product of A and B, and then applying a process for modular reduction of the product to a number smaller than N. This is, however, not a preferred approach since a modification of this approach merges together operations of multiplication and modular reduction to produce a more efficient process and simpler circuit. For the purpose of providing a better understanding of the prior invention, it is assumed herein that A, B and N are all m digit numbers. The product of A and B is normally a number with 2m digits. To reduce the size of the register for holding the product, one modularly reduces the product whenever A is multiplied by a single digit of B. Note that by a “digit of B” is meant a block of k bits representing Bᵢ. This approach reduces the size of the register by a factor close to two.

To best understand this approach, it is supposed that A=Aₘ₋₁R^{m-1}+ . . . +A₁R+A₀, and that B=Bₘ₋₁R^{m-1}+ . . . +B₁R+B₀. Then A×B is obtained sequentially as A×B=(( . . . (ABₘ₋₁R+ABₘ₋₂)R+ . . . )R+B₀). In each step of the iteration, the partial product ABᵢ is added to a temporary product. The sum is then multiplied by R, as the algebra indicates. However, it is noted that, because of the choice for R, the multiplication by R is performed by a shift operation and does not require special multiplication circuits. In this regard attention is directed to adder 206 where there are k bits of zeroes provided as the lower order k bits of the output of adder 206, effectively performing the desired multiplication. Any additional hardware cost is minimal. A modular reduction process is then followed, as described above, to produce the desired result, namely: A×B mod N. The following is a description of the process employed.

Modular Multiplication (Algorithm I): Z=A×B mod N

Inputs to the process:

A=Aₘ₋₁R^{m-1}+ . . . +A₁R+A₀

B=Bₘ₋₁R^{m-1}+ . . . +B₁R+B₀

Z=ZₘR^{m}+ . . . +Z₁R+Z₀

R_{N}=R^{m+1} mod N, R_{N}<N

The process:

Step 1. Z=0

Step 2. For i=m−1 to 1, do

Z=Z+ABᵢ

If carry=1, then Z=Z+R_{N}, else Z=Z+0=Z.

Z=(Z−ZₘR^{m})R+ZₘR_{N}

If carry=1, then Z=Z+R_{N}, else Z=Z+0=Z.

Step 3. Z=Z+AB₀

Step 4. Modular reduction on Z to a value less than or equal to N.

A block diagram of a circuit for carrying out the process indicated above for Steps 1-3 of Algorithm I above for modular multiplication is shown in FIG. 2. Z register 201 holds the temporary result. At the beginning of the process the contents of register 201 are set to zero. Likewise at the start of the process, R_{N} register 200 holds the value R^{m+1} mod N, which is a constant during the entire process. Multiplicand register 202 contains the binary representation for A which, as is indicated above, is considered to be partitioned into m “chunks” of k bits each. Likewise, multiplier B is also considered to be partitioned into m “chunks” of k bits each, with the higher order bits of multiplier B being supplied to multiplier 203 at the rate of k bits at a time, that is, at each iteration of the process. Clearly, Bₘ₋₁ is supplied first to multiplier 203, then Bₘ₋₂, and so on down to B₁. The output of multiplier 203, ABᵢ, is supplied to adder 204 where it is added to the current value in Z register 201 to form Z+ABᵢ, as set forth in step 2 above. If the addition in adder 204 produces a carry signal output, then, under control of AND gate 205 which receives the carry signal from adder 204, R_{N} is added to perform the operation Z=Z+R_{N}, also as described in step 2 above. This latter operation is carried out by adder 206. Furthermore, to produce the same effect as a multiplication by R, k bits, all of which are zero, are provided as if they were the rightmost k bits from the output of adder 206. The high order or leftmost k bits from the output of adder 206, representing the leftmost k bit positions in Z, namely Zₘ, are supplied to multiplier 207 to form the product ZₘR^{m} as is also shown in step 2 above, noting again that R_{N}=R^{m+1} mod N=R R^{m} mod N. It is also especially noted that after k bits, all of which are zero, are appended to the rightmost bit positions of the output from adder 206, only the rightmost (m+1)k bits (out of a total now of (m+2)k bits) are supplied to adder 208. This effectively removes the high order k bits from Z; stating this more symbolically, the output of adder 206 which is supplied to adder 208 is (Z−ZₘR^{m})R, as specified in step 2 above. When the addition operation in adder 208 produces a carry indication, AND gate 209 receives it and uses it to control whether or not R_{N} is added, in adder 210, to the output of adder 208. The output of adder 210 is returned to register 201 which contains the partial result of the process. The process continues for (m−1) iterations as new values for the “digits” of B (that is, the Bᵢ values) are supplied from a shift register for B (not shown) to multiplier 203. In the last of the total of m steps the value B₀, the least significant digit of B is provided to multiplier 203 and the circuit computes the final value of Z=A×B mod N.

Modular Multiplication (Algorithm II): Z=A×B mod N

The process described below is a variation of Algorithm I.

Inputs to the process:

A=Aₘ₋₁R^{m-1}+ . . . +A₁R+A₀

B=Bₘ₋₁R^{m-1}+ . . . +B₁R+B₀

Z=ZₘR^{m}+ . . . +Z₁R+Z₀

Precalculate: R_{N}=R^{m+1} mod N, R_{N}<N

The process:

Step 1. Set Z=0

Step 2. For i=m−1 to 0, do

Z=(Z−ZₘR^{m})R+ZₘR_{N}

If carry=1, then Z=Z+R_{N}, else Z=Z+0=Z.

Z=Z+ABᵢ

If carry=1, then Z=Z+R_{N}, else Z=Z+0=Z.

Step 3. Sequential modular reduction on Z to a value less than N.

The operation of the circuit shown in FIG. 3 is similar to that shown in FIG. 2. For ease of understanding, it is possible to map the operations carried out in Algorithm II above with specific circuit components in FIG. 3. For example, in forming (Z−ZₘR^{m})R+ZₘR_{N}, the addition is carried out in adder 307 and the multiplication for ZₘR_{N} is carried out by multiplier 306. The expression (Z−ZₘR^{m})R is produced by the introduction of k bits of zeros as the low order output bits from Z register 301, which is used to store intermediate results between iterations, and by the selection of the leftmost k bits of Z register 301. (This is similar to the operations carried out by adder 206 in FIG. 2.) If there is a carry output from adder 307, under control of AND gate 308, adder 309 forms the result Z+R_{N}, the value R_{N}, from register 300, being added only if there is a carry out from adder 307. The formation of the expression Z+ABᵢ is produced using multiplier 303, with input A from register 302 and Bᵢ, to produce the product ABᵢ which is added via adder 304 to the current intermediate value for Z. Again, if there is a carry produced by the addition in adder 304, the carry signal and AND gate 310 provide a mechanism for the conditional addition of R_{N} in the last portion of step two in Algorithm II above, as carried out by adder 305. The output of adder 305 is provided as a feedback to Z register 301 and the process thus continues with the next of the m iterations with the next lower order digits of B (that is, the next Bᵢ) being supplied to multiplier 303.

The circuit shown in FIG. 3 represents a preferred embodiment of the prior invention since it permits the two more computationally intensive multiplication operations, as carried out by multipliers 306 and 303, to have a greater overlap in time. The circuit in FIG. 3 is thus also characterizable as having a shorter critical path than the circuit of FIG. 2. In short, the circuit of FIG. 3 provides faster speeds of operation. It is also noted that pipelined implementations of the circuits presented herein is also possible.

It is noted that while the values of m, n and k appear to be limiting, this is not really the case since it is always possible to pad the leftmost or higher order bit positions with zeros to whatever extent desired to achieve values that are reasonable and effective. In particular, the choice of k=32 is a convenient one for the current state of the art in terms of circuit design. Typically, the value of mk is a number like 1,024; 2,048 or 4,096, or a number close to one of these. In general, the values of m and k are chosen for convenience of design and as a function of the degree of security one wishes to achieve in a cryptography system in which the prior method and circuits are employed. It is also noted that the prior invention also easily accommodates the situation in which the number of bits or k-bit blocks in A and B are different. In this respect the prior method and system are more general than the Montgomery algorithm. In general, if this is the case, the shorter factor is supplied through the Bi input for greater speed since this reduces the number of iterations. However, if the size of the A register (202 or 302) is of concern, then register size can be traded off for speed by feeding the longer factor into the system as the Bᵢ input.

### Present Invention

Suppose that A=AₘR^{m}+Aₘ₋₁R^{m-1}+ . . . +A₁R+A₀, where A is considered as being made up of m+1 blocks with each block having k bits. Further suppose that N=Nₘ₋₁R^{m-1}+ . . . +N₁R+N₀, where R^{m-1}<N, R=2^{k}, 0≦Aᵢ, Nᵢ≦R−1, and Aₘ and Nₘ₋₁ are non zero. In this situation it can be said that A has one more “digit” than N, namely Aₘ.

Consider first the division of R^{m+1} by N. Since it is clear that R^{m-1}<N, let R^{m+1}/N=W₁R+W₀+W′, where 0≦W₁, W₀≦R−1, and W′<1. We thus set out what is referred to below as equation (1):

R^{m+1}/N=W₁R+W₀+W′ (1)

We thus also have:

$$\begin{matrix}A / N = ( A / {R}^{m + 1} ) ( {R}^{m + 1} / N ) \\ = ( {A}_{m} / R + {A}_{m - 1} / {R}^{2} + … ) ( {W}_{1} R + {W}_{0} + {W}^{′} ) \\ = {A}_{m} {W}_{1} + ( {A}_{m} {W}_{0} + {A}_{m} {W}^{′} + {A}_{m - 1} {W}_{1} ) / R + \\ ( {A}_{m - 1} {W}_{0} + {A}_{m - 1} {W}^{′} + {A}_{m - 2} {W}_{1} ) / {R}^{2} + … ,\end{matrix} \qquad ( 2 )$$

where this last equation has been denoted as equation (2) for reference purposes.

Suppose now that q′=AₘW₁+└(AₘW₀+Aₘ₋₁W₁)/R┘ is an estimate of the quotient of A/N. Then q′<q=└A/N┘. That is to say, the estimate q′ is never over the actual value. Since A<AₘR^{m}+Aₘ₋₁R^{m-1}+R^{m-1} and W′<1, we have also have:

A/N<(Aₘ/R+Aₘ₋₁/R²+1/R²)(W₁R+W₀+1),

A/N<AₘW₁+(AₘW₀+Aₘ₋₁W₁)/R+(W₁+Aₘ)/R+(Aₘ₋₁+1)(W₀+1)/R²,

A/N<AₘW₁+(AₘW₀+Aₘ₋₁W₁)/R+3.

Thus, q−q′≦3. The estimate of the quotient is no more than 3 on the low side. We have the following algorithm.

### Present Invention: Algorithm #1

1. Precalculate W₁ and W₀, where W₁R+W₀ is the quotient of R^{m+1}/N.

2. Calculate q′=AₘW₁+└(AₘW₀+Aₘ₋₁W₁)/R┘.

3. Calculate A=A−q′N

4. If A<N, the calculation is complete, otherwise, apply A=A−N or A=A−2N until A<N.

To increase the accuracy of the estimate q′, one can also pick up additional terms from equation (2) above. One can also start with R^{m+2}/N to obtain equation (3) below:

R^{m+2}/N=W₂R²+W₁R+W₀+W′, (3)

where 0≦W₂, 0≦W₁, W₀≦R−1, and W′<1.

Following the same derivation, suppose that A=AₘR^{m}+Aₘ₋₁R^{m-1}+Aₘ₋₂R^{m-2}+A′, where A′<R^{m-2}. We thus have, as equation (4):

$$\begin{matrix}A / N = ( A / {R}^{m + 2} ) ( {R}^{m + 2} / N ) \\ = ( {A}_{m} / {R}^{2} + {A}_{m - 1} / {R}^{3} + {A}_{m - 2} / {R}^{4} + \\ {A}^{′} / {R}^{m + 2} ) ( {W}_{2} {R}^{2} + {W}_{1} R + {W}_{0} + {W}^{′} ) .\end{matrix} \qquad ( 4 )$$

Now suppose that one defines Q as follows:

Q=AₘW₂+(Aₘ₋₁W₂+Aₘ₋₂W₁)/R+(Aₘ₋₂W₂+Aₘ₋₁W₁+AₘW₀)/R². (5)

Then, we also have:

A/N−Q=W₂A′/R^{m+4}+W₁R(Aₘ₋₂/R⁴+A′/R^{m+2})+W₀(A−AₘR^{m})/R^{m+2}+W′A/R^{m+2}<(R−1)/R²+(R−1)²/R³+(R−1)/R³+(R−1)/R²+1/R<4/R.

Suppose that q′=└Q┘=AₘW₂+└Aₘ₋₁W₂+Aₘ₋₂W₁)/R+(Aₘ₋₂W₂+Aₘ₋₁W₁+AₘW₀)/R²┘ be the integer part of Q. Then the quotient of A/N is the same as q′ most of the time and is larger than q′ by 1 with a probability of less than 4/R, which is very small for R=2³². Note that the calculation of q′ involves six single digit multiplications. The divisions by R and R² can be carried out by discarding the least significant digits from the products. Thus, we have an alternative to Algorithm 1 as follows.

Present Invention: Algorithm #2

1. Precalculate W₂, W₁ and W₀, where W₂R²+W₁R+W₀ is the quotient R^{m+1}/N.

2. Calculate q′=AₘW₂+└(Aₘ₋₁W₂+Aₘ₋₂W₁)/R+(Aₘ₋₂W₂+Aₘ₋₁W₁+AₘW₀)/R²┘

3. Calculate A=A−q′N

4. If A<N, done. Otherwise, A=A−N.

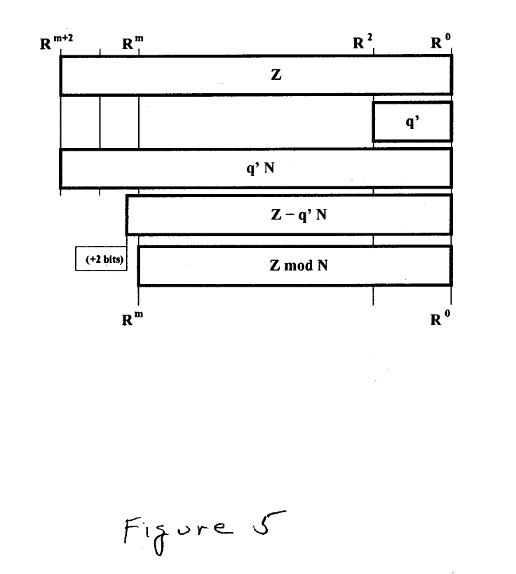

FIG. 5 illustrates the course of action taken when the contents of the Z register are less than 2 k bits in length.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

The invention claimed is:

1. A method for producing A mod N, where A is a binary number considered as having n blocks with k bits each and where N is a binary number considered as having m blocks of k bits each, said method comprising the steps of:
loading the value R_{N}=R^{m+1} mod N, where R=2^{k}, into a first register;
loading a second register for the variable Z with the high order m blocks for A; and
for values of i ranging from n−1 to m+1, replacing the value in said second register with the value Z−ZᵢRⁱ+ZᵢR_{N}R^{i-m-1}, but if the addition operation produces a carry out indication, replacing the value in said second register instead with the value Z−ZᵢRⁱ+ZᵢR_{N}R^{i-m-1}−Rⁱ+R_{N}R^{i-m-1}, where Z is the current value in said second register and Zᵢ is the high order k bits in said second register and shifting said second register left and shifting into, on the right thereof, the next k bit block of A and determining if the contents of said second register are less than 2 k bits and if so determining A mod N without further iteration from a subportion of said second register.
